(19) United States
(12) Patent Application Publication
(10) Pub. No.: US 2006/0206506 A1
(43) Pub. Date: Sep. 14, 2006

(54) Expenditure accounting management system and method

(76) Inventor: Thomas J. Fitzpatrick, Chapel Hill, NC (US)

Correspondence Address: MACCORD MASON PLLC, 300 N. GREENE STREET, SUITE 1600, P. O. BOX 2974, GREENSBORO, NC, 27402, US

(21) Appl. No.: 11/213,577

(22) Filed: Aug. 26, 2005

Related U.S. Application Data
(60) Provisional application No. 60/660,671, filed on Mar. 11, 2005.

(51) Int. Cl. G06F 7/00

(52) U.S. Cl. 707/100

(57) ABSTRACT

A web based payment card software application for an expenditure accounting management automation system that provides a plurality of event code identifiers for processing, reporting and recording expenditure spending related to transaction data activity, including a one of a plurality of expenditure identifiers associated with line item transaction data comprising multiple line items of products and/or expenditure identifiers. The expenditure identifiers and event code identifiers along with their associated GL designated accounts enable automated processing of expense and procurement account data by cardholders.

This application claims the benefit of U.S. Provisional Patent Application No. 60/660,671, filed Mar. 11, 2005.

### BACKGROUND OF THE INVENTION

(1) Field of the Invention

The present invention relates generally to a software method for an automated expenditure accounting management system and, more particularly to a web based payment card software application for an automated expenditure accounting management system that provides a plurality of identifiers for processing, reporting, recording and reimbursing/collecting of expenditure spending related to each line item of transaction data comprising multiple line items of activity associated with a cardholder's purchase of products (goods and/or services).

(2) Description of the Prior Art

A business may incur a significant cost for processing, reporting, recording, reimbursing, collecting and otherwise managing spending transaction data, especially where a business has several hundred employees submitting spending reports for expenditures. Semi-automated systems and service providers based around those semi-automated systems have been developed to provide a means for reducing those costs. Semi-automated systems typically provide spending reports and information for monitoring and controlling most spending transaction data. However, these semi-automated systems typically require employees to allocate transaction data details among various accounting classifications manually for proper disclosure and ledger recording purposes (e.g. travel costs, entertainment costs, other costs and proper ledger account codification). Semi-automated systems also do not provide a central database for the accumulation of all transaction data activity, particularly transaction data involving employee incurred cash spending and employee personal vehicle usage mileage transaction expenditures. Moreover, spending transaction data incurred, but which has not been submitted and processed as part of an employee spending report or expense voucher (accrual spending transactions) is not adequately captured until after the voucher processing of a spending report is complete. Thus such accrual spending transactions are not disclosed on a timely basis and are inadequately reported for accounting disclosure and ledger recording purposes.

Additionally, semi-automated systems generally do nothing to: (a) eliminate the accounting processing cost of matching reported spending transaction data to actual cash expenditure outlays made by a business (direct vendor billings, payment card billings, and cash expenditure & mileage reimbursement versus the reported spending activity), (b) automate the ledger accounting recording classification function of transaction data detail, or (c) automate the employee reimbursement/repayment function. For each spending report processed, the business's accounts payable personnel is required to match spending report costs to direct billed vendor/payment card billings, manually sort expenditures into their appropriate ledger account classification (based on the nature of the expenditure) and voucher the spending report for employee reimbursement/repayment. Thus there is a need for a new and improved software method of automating expenditure accounting management processing, reporting, and recording within a centralized database for all spending transaction data.

### SUMMARY OF THE INVENTION

The present invention meets these needs by providing an automated expenditure accounting management system. A computer system is configured to access transaction data representing a client's expenditures in exchange for a plurality of products. The transaction data includes one product identifier associated with one of the products and a different product identifier associated with a different one of the products. The computer system is configured to store the transaction data in association with an expenditure identifier that has a designated general ledger (GL) account in a client GL accounting system associated with the one product identifier. A different expenditure identifier that has the same or a different designated GL account in a client GL accounting system associated with the different product identifier. The computer system also provides the cardholder, cardholder's supervisor and client personnel including the client accounting system access to the stored transaction data and stored identifiers.

The present invention may also be regarded as providing a method of automated expenditure accounting management including associating a product identifier associated with a product and an expenditure identifier designating a GL account in a client accounting system, as well as associating a product identifier associated with a product and an event code identifier designating a GL account in a client accounting system. The method may include associating a different product identifier associated with a different product and a different expenditure identifier designating the same or a different GL account in the client accounting system, as well as the method may include associating a different product identifier associated with a different product and a different event code identifier designating the same or a different GL account in the client accounting system. The method may include storing the transaction data including the product identifiers, the associated expenditure identifiers and event code identifiers, and providing the cardholder, cardholder's supervisor and client personnel including the client accounting system access to the transaction data and associated identifiers.

The present invention may also be embodied as a storage medium comprising data combinable with a computer system such that the computer system associates a product identifier and an expenditure identifier designating a GL account in a client accounting system, as well as associating a product identifier and an event code identifier designating a GL account in a client accounting system. The computer system further associates a different product identifier and the same or a different expenditure identifier designating a GL account in a client accounting system, as well as associating a different product identifier and the same or a different event code identifier designating a GL account in a client accounting system. The computer system stores transaction data including the product identifiers, associated expenditure identifiers and event code identifiers. The computer system provides the client accounting system access to the transaction data and associated expenditure identifiers and event code identifiers.

The present invention may also be regarded as a method of spending accounting management automation including a communication network for: (1) granting client administrators access to the event code identifier and associated designated GL account database file for the purpose of adding new event code identifiers, (2) granting client employees access to the employee card transaction data, that includes a plurality of line item (products) and expenditure identifiers associated with each line item. This enables the employees to review transaction data and associated expenditure identifiers accuracy, make corrections to expenditures identifiers, if necessary, and choose one of a plurality of client event code identifiers for processing, reporting and recording expenditure activities. The method typically includes granting the client accounting personnel access to automated software ledger recording activity summary reports that summarize transaction data between reported and approved employee spending reports, and reported and unapproved employee spending reports, as well as unreported transaction expenditures. Such later data is thus an unreported accrual transaction. The client accounting personnel can also access exception and non-compliance management reports. Taken as a whole, these can provide an automated means for proper ledger recording treatment and classification of transaction data for the client and compliance with client policies.

The invention can also be considered as a point of sale apparatus for a merchant including a memory holding a data collection of purchased product(s) in a single transaction with a payment card customer, each of the products being identified as a product identifier with an expenditure identifier and an event code identifier. The data collection includes an amount associated with each product identifier and a cardholder payment card number to be charged in the single transaction. A transmitter transmits the data collection to a payment card processor associated with the payment card used by the cardholder customer for payment to the merchant.

In another aspect, the invention provides a payment card company automation apparatus including a receiver to receive from a merchant a data collection of purchased product(s) in a single transaction with a payment card customer, each of the product(s) being identified with an expenditure identifier and an event code identifier. The data collection includes an amount associated with each expenditure identifier and a cardholder payment card number to be charged in the single transaction. A memory holds the received data collection, and a transmitter transmits the data collection to a client or the associated cardholder in a manner to communicate payment details to merchants.

In another aspect, the invention provides a client and/or cardholder automation apparatus including a receiver to receive from a payment card company a data collection of purchased product(s) in a single transaction with a cardholder customer, each of the product(s) being identified with an expenditure identifier. The data collection includes an amount associated with each expenditure identifier and a cardholder payment card number charged in the single transaction. A memory holds the received data collection, and a processor apparatus accumulates a plurality of received data collections and associates charged amounts to cardholder accounting GL accounts according to received expenditure identifiers.

These and other aspects of the method and system will become apparent to those skilled in the art after a reading of the following description of embodiments of the method and system when considered with the drawings.

### BRIEF DESCRIPTION OF THE DRAWINGS

FIG. 1 is a schematic diagram depicting an automated expenditure accounting management system according to an embodiment of the invention.

FIG. 2 is a flow diagram depicting a method of expenditure accounting management according to an embodiment of the invention.

FIG. 3 is also schematic diagram depicting a method of expenditure accounting management according to an embodiment of the invention.

FIG. 4 is a schematic diagram depicting an embodiment of Step 500 of FIGS. 2 and 3.

FIG. 5 is a schematic diagram depicting an embodiment of Step 510 of FIGS. 2 and 3.

FIG. 6 is a schematic diagram depicting an embodiment of Step 520 of FIGS. 2 and 3.

FIG. 7 is a schematic diagram depicting an embodiment of Step 530 of FIGS. 2 and 3.

FIG. 8 is a schematic diagram depicting an embodiment of Step 540 of FIGS. 2 and 3.

FIG. 9 is a schematic diagram depicting an embodiment of Step 560 of FIGS. 2 and 3.

FIG. 10 is a schematic diagram depicting an embodiment of Step 570 of FIGS. 2 and 3.

FIG. 11 is a schematic diagram depicting an embodiment of Step 580 of FIGS. 2 and 3.

### DESCRIPTION OF THE PREFERRED EMBODIMENTS

The illustration and description herein are for the purpose of describing embodiments of the invention and are not intended to limit the invention to embodiments described or illustrated. Those of ordinary skill in the art will recognize that various and numerous configurations of the invention are defined by the appended claims.

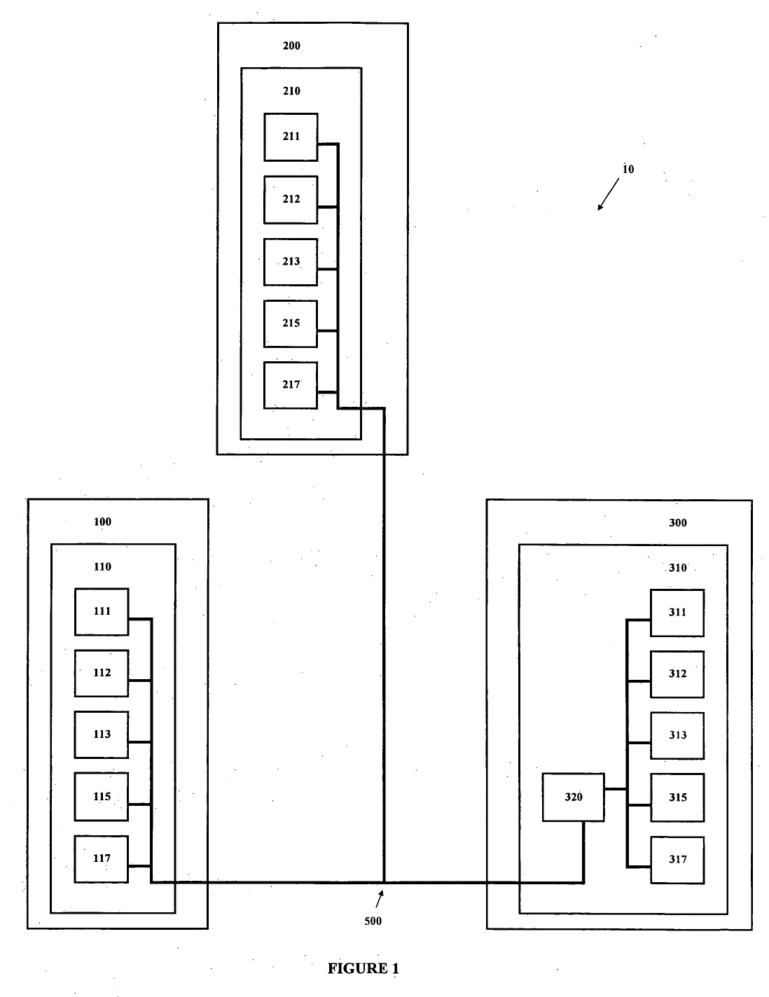

FIG. 1 is a schematic representation of an automated expenditure accounting management system 10 according to an embodiment of the present invention. The embodiment of the system 10 depicted by FIG. 1 includes a merchant subsystem 100, a payment card company subsystem 200, and a client/cardholder subsystem 300. Any organization or individual of any kind providing goods or services, or otherwise collecting, distributing, or exchanging assets can be associated with the merchant subsystem 100. For example, a merchant may be a hotel, restaurant, fuel station, laundry service, resort, airline company, travel agency, real estate company, car rental agency, utility company, health care provider, office supplies retailer, raw materials provider, insurance company, government, or department thereof, child care provider, professional association, department store, manufacturer, mortgagor, etc. An organization or business providing goods or services to a client/cardholder is associated with the payment card company subsystem 200, while the client/cardholder are associated with the client subsystem 300. A communications network 500 connects the merchant subsystem 100, the payment card company subsystem 200, and the client subsystem 300. In the preferred embodiment of the invention, the communication network is a public network, such as the internet or a private network, such as an intra network or local area network (LAN). The communications network 500 can be an electronic network. The communications network 500 provides for the transfer and access to data between the subsystems of the expenditure accounting management system 10. Preferably the network has security to prevent theft, counterfeiting or alteration of data being transmitted.

FIG. 1 also shows a merchant subsystem 100 for an automated expenditure accounting management system 10 according to an embodiment of the invention. In a preferred embodiment of the system 10, the merchant subsystem 100 includes a merchant server 110, connected to a communication network 500. The server unit 110 includes a communication unit 111, a data storage unit 112, a control unit 113, a functional unit 115, and an input unit 117. The communication unit 111 may be a modem, network card, or integrated digital services network (ISDN) connection that controls communication between the server 110 and communication network 500. The data storage unit 112 typically includes a cache memory, RAM, ROM, and/or hard disk storing data in the server 110. The control unit 113 includes a processor, such as a central processing unit (CPU) in the server 110. The functional unit 115 includes the system software and application programs instructions executed by the control unit merchant subsystem 113. Examples of software that can be included in the functional unit are operating systems and database management systems. The input unit 117 includes one or more devices for putting data into the data storage unit 112 of the server 110. Examples of devices that can be included in the input unit 117 are keyboards, point-of-sale terminal, smartcard terminal, smartcard readers, touch screens, RFID readers, microphones, mouse, scanners, and so forth.

FIG. 1 shows a payment card company subsystem 200 for an automated expenditure accounting management system 10 according to an embodiment of the invention. The payment card company subsystem 200 includes a payment card company server unit 210 connected to a communication network 500. The server 210 includes a communication unit 211, a data storage unit 212, a control unit 213, a functional unit 215, and an input unit 217. The data storage unit 212 includes one or more databases storing information associated with payment card user and also payment card transaction information. The data storage unit 212 typically includes a cache memory, RAM, ROM, and hard disks for storing data in the server unit 210. The data storage unit 212 may include such information as payment card numbers, division names and addresses of the client, business and personal account numbers, business and personal telephone numbers, business and personal email addresses, business contacts, merchant names and addresses, merchant numbers, merchant, telephone numbers and email addresses, wire transfer information, expenditure amounts, approval dates, purchasing dates, scheduled settlement dates, settlement accounts, approval numbers, mileage entries, identifiers, transaction descriptions, spending limit criteria, expense allocations, report numbers, business spending restrictions and authorization, passwords, and so forth. The data storage unit 212 may also include information that will identify the employee cardholder to certain payroll related functionality for reimbursement/repayment purposes, as well as proper department ledger recording classification and accounting treatment. The control unit 213 includes a CPU in the server unit 210. The functional unit 215 includes software stored in the data storage unit 212 of the payment card company server unit 210. The functional unit 215 includes software and application program instructions executed by the card company subsystem 200. Examples of software in the functional unit are operating systems and database management systems. The communication unit 211 includes a modem, network card, or integrated services digital network connection, such that it controls communication between the server unit 210 and communication network 500.

FIG. 1 also illustrates a client/cardholder subsystem 300 for an automated expenditure accounting management system 10 according to an embodiment of the invention. The client/cardholder subsystem 300 is associated with an organization such as a business, or a division/department thereof; an individual or other purchaser of goods and services available from merchants. The client/cardholder subsystem 300 includes a client server unit 310. The client server unit 310 includes a computer in communication with the payment card company server 210 via the communication network 500. The client server unit 310 typically includes a communication unit 311, a data storage unit 312, a control unit 313, a functional unit 315 and an input unit 317. The control unit 313 includes a CPU in the server unit 310. The data storage unit 312 may include a cache memory, RAM, ROM and hard disks for storing data in the client server unit 310. The communication unit 311 may include a modem, network card, or integrated services digital network connection, such that it controls communication between the client server unit 310 and communication network 500. The functional unit 315 includes software stored in the data storage unit 312 of the client server unit 310. The functional unit 315 includes system software and application program, instructions executed by the client subsystem 300. Examples of software in the functional unit 315 are operating systems and database management systems. In addition, one or more user terminals 320 communicate electronically with the client server unit 310. A user terminal 320 is a device providing access to the server unit 310 or to the payment card company subsystem 200, e.g. a personal computer, personal digital assistant, or other access device. A client administrator would configure the user terminal 320 to access server unit 310, while the payment card company subsystem access via the user terminal 320 would be by user identification and password security maintained on the payment card company server 210.

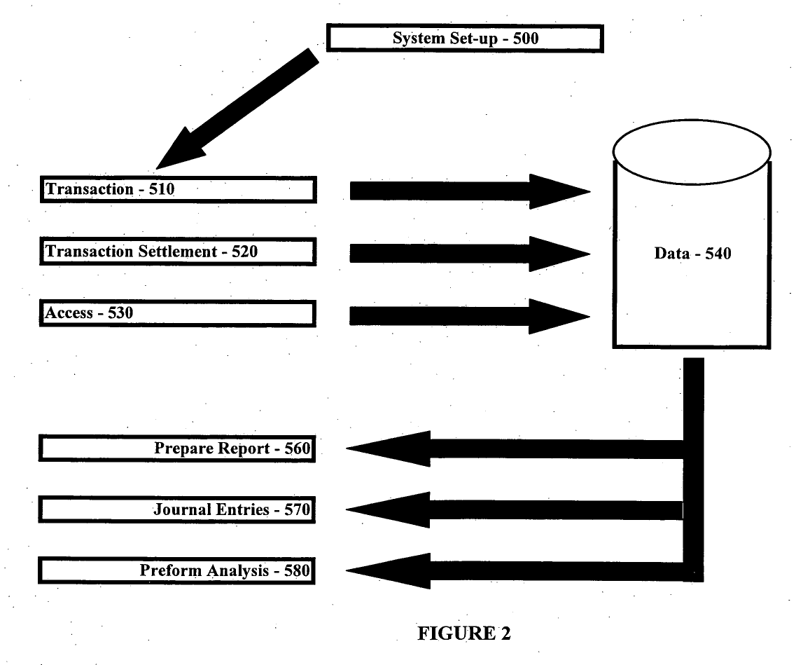

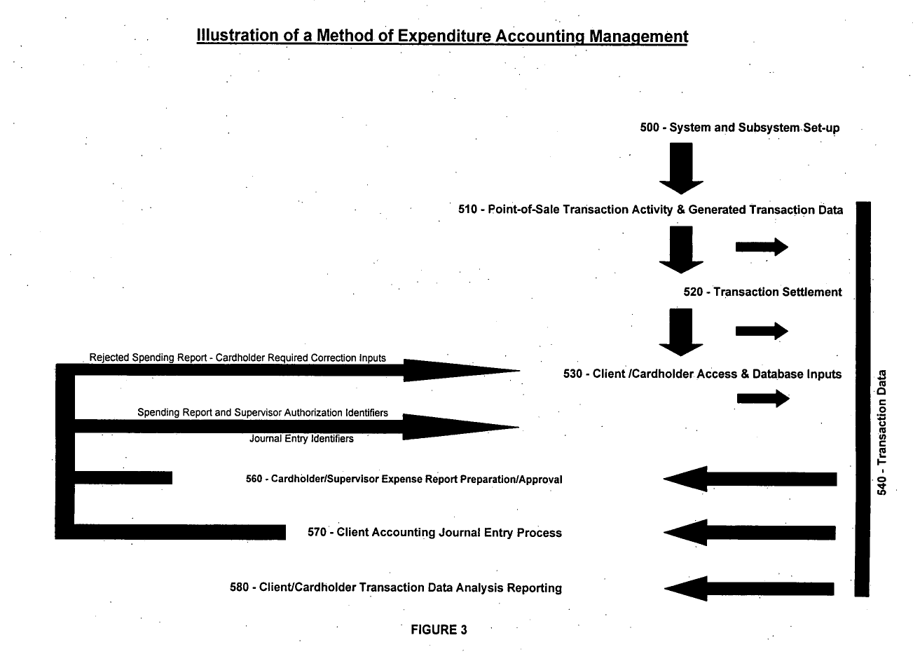

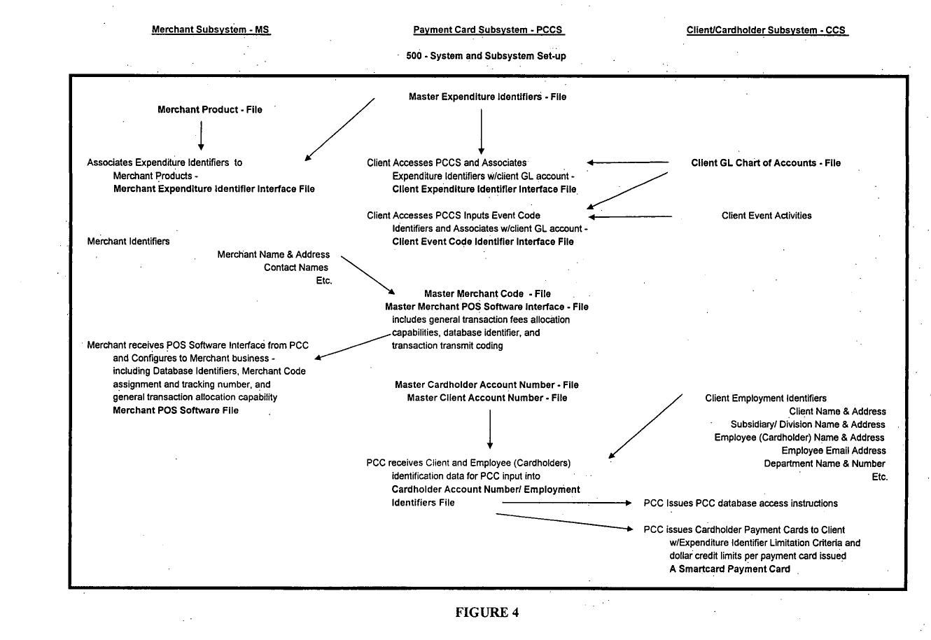

FIGS. 2 and 3 illustrate a method of expenditure accounting management. Step 500 of the method, also shown in FIG. 4, includes formation of a merchant alliance association between a payment card company and one or more merchants, as well as the client membership formation. This step generally represents the set-up procedures that merchants and clients in conjunction with the payment card company will perform as the prerequisites to transacting any payment card activities. Existing merchant alliances and client members may simply be upgraded to use the invention. The merchant and the payment card company, as well as, the client and the payment card company agree to conditions defining a relationship that permits cardholders to purchase goods or services from the merchant by demonstrating membership. Typically, the payment card company establishes a database storing client information and authorized cardholder account data, and payment cards are issued to client employees. The issued payment cards may take the form of smartcards. The client is usually a business seeking to reduce the cost of accounting for employee and project expenditures. Thus, the client controls which employees are to receive a payment card which is then issued by the payment card company to a client administrator, the employee directly, or other authorized individual. Cardholders incur expenditures during the course of performing their duties related to the business. Therefore, certain expenditures incurred by cardholders are reimbursable by the client to the employee cardholder in accordance with the client's policies regarding reimbursable expenditures. Other expenditures are personal and are not reimbursable. The payment card company may enable the payment card for both personal and business expenditures by a cardholder or for just business expenditures by the cardholder. Accordingly, the payment card company stores the transaction data related to expenditures as either a business or a personal expenditure.

The set-up procedures for merchant's in Step 500 include the receiving of a data file from the payment card company that provides the current listing of available expenditure identifiers. The merchant associates each of its products to one of a plurality of expenditure identifiers, thus generating an interface file of merchant expenditure identifiers on the merchant subsystem. Additionally, a merchant receives an interface software file from the payment card company (a merchant POS software file) that provides the merchant point-of-sale apparatus the ability to transmit transaction data to the payment card company with the requisite transaction data with associated expenditure identifiers in the requisite format. This is an initial set up process required at least once for every merchant in the alliance. In addition, each subsequent new product a merchant offers will be associated with an expenditure identifier. The expenditure identifier is a code that identifies one or more of a plurality of goods or services offered by a merchant. For example, the merchant can be a lodging services provider, such as a hotel, that provides a variety of products or services—such as daily room charges, daily room taxes, hotel restaurant charges, lounge charges, telephone usage charges, laundry charges, room entertainment charges, etc. The expenditure identifier is a code, such as an alphanumeric identifier, associated with one of the products, while a different product may have the same or a different expenditure identifier. A plurality of the merchant products can be associated with each expenditure identifier. For example, the merchant products identified above as a daily room charge and as a daily room tax would have the same expenditure identifier associated to them. Other merchant products offered by the hotel, such as the restaurant charges, can be associated with a different expenditure identifier. The merchant's generally will associate products to expenditure identifiers on a basis that will provide a meaningful cost expenditure analysis for a business organization. Preferably, the expenditure identifiers are stored corresponding to a description of a merchant product in a database in a merchant subsystem 100.

The set-up procedures for clients in Step 500 includes one or more client user terminals configured to access the payment card company subsystem by a client administrator for inputting a GL designated account in association with the plurality of payment card company defined expenditure identifiers, as well as to input a plurality of client defined event code identifiers with its associated GL designated accounts via the communication network to distinguish transaction data activity between a multiple of various client activities, thus generating a client specific expenditure identifier file with associated client GL accounts and a client specific event code identifier file with GL accounts on the payment card company subsystem. Typically, this step is performed using a public communications network such as the internet. The client administrator is any person designated by the client to input event code identifiers and GL accounts into the payment card company subsystem. Event code identifiers are client specific codes for identifying a plurality of various client activities; these event code identifiers are for specific client utilization only. They may have applicability across the entire client employee population or for specific client subgroups (departmental, project job costing, user, fixed asset capitalizations, etc.). Expenditure identifiers and event code identifiers are provided to correspond with an account in a client accounting system. Two or more expenditure identifiers, as well as two or more event code identifiers can correspond with the same account in the client accounting system. GL designated accounts associated with event code identifiers will take precedence over expenditure identifier GL designated accounts. In another initial set-up procedure, the client provides the payment card company information about client employees related to establishing a cardholder account number with employment identifiers (names, addresses, department affiliations, expenditure identifier limitation data, etc.)—the payment card company inputs this information with an association to a specific cardholder account number into the payment card company subsystem and issues a payment card accordingly. The payment card company provides access to transaction data representing charges incurred by a client. Client event code identifiers are accessible to cardholders through the payment card company subsystem to provide consistent handling of expenditures across the entire client employee population. Such as in the lodging example, if employees from the same client but different departments attended the same event, the expenditures would be classified similarly based on the cardholder departmental designation (employment identifier) and the GL account designated with that event. The client uses the transaction data, expenditure identifiers and event code identifiers to automate its accounting process and eliminate the need to sort transaction data manually to a proper client account.

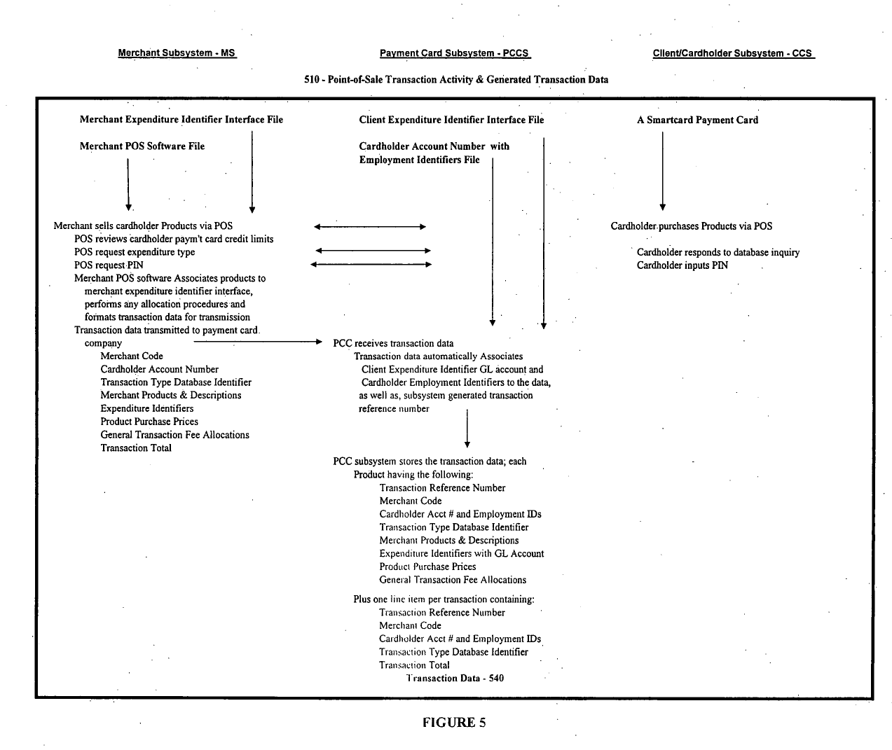

Step 510 of FIGS. 2 and 3 depicts a transaction between a cardholder and a merchant in conjunction with a point-of-sale apparatus, as shown in more detail in FIG. 5. For example, with the lodging services provider, the transaction can occur when the cardholder checks out of the hotel. Typically, the hotel retrieves charges incurred by the cardholder during a stay from a database maintained by the hotel in its merchant subsystem 110 to produce an itemized billing of all charges incurred by the cardholder during a stay at the hotel. Thus, the billing can include a plurality of line items, one line for each merchant product purchased. The transaction data usually includes a price for each of the charges incurred and a description of the corresponding product. If there is any general transaction charge (i.e. sales tax, value added tax, etc.) which is determined on a basis of all the products purchased, the merchant POS software will allocated that charge to each of the products on the same basis that the charged was determined by the merchant's accounting software. As part of the checkout process, a cardholder will respond to a point-of sale terminal inquiry regarding the nature of the transaction—business or personal. Thus all line items associated with the transaction are designated business or personal by associating a database identifier to all of the transaction line items.

Step 510 also depicts the transaction data being generated, transmitted and stored on the payment card company subsystem as a result of the transaction between the cardholder and the merchant. The transaction data may include one line for each merchant product purchased with its corresponding associated expenditure identifier or one line for each expenditure identifier associated with the transaction, plus a database identifier, the cardholder account number, purchase price of the product or the expenditure identifier subtotal amount, and an amount representing a pro-rata allocation of any general transaction fees associated to the product or expenditure identifier purchased. Additionally, the transaction data will include one line item that represents the total amount of the transaction. The payment card company subsystem is configured to receive and store the merchant transaction data and associate the client GL designated account to the expenditure identifiers for each of the line items of the transaction.

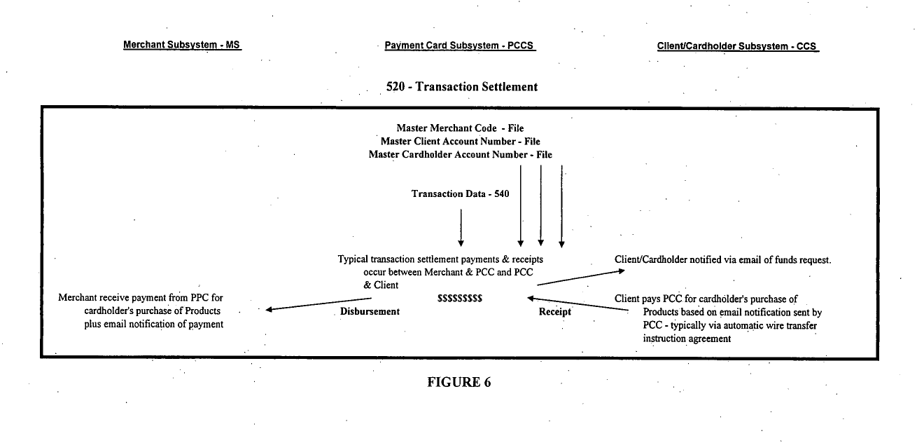

At step 520 of FIGS. 2 and 3, the payment card company subsystem is configured to store settlement information on payments made to the merchants by the payment card company, as well as collections received from clients/cardholders by the payment card company based on the transaction data as shown in more detail in FIG. 6. The payment card company is configured to provide email notification of settlement payments to merchants. Additionally, the payment card company subsystem is configured to send email notification to client and/or cardholders of settlement requests with an automatic pay plan funds transfer or scheduled due date. Settlement payments and settlement collections may be effected through the utilization of either an electronic banking system transfer (an automatic pay plan) or through the processing of accounting disbursement/deposit activity, which is linked to the transaction data. Established merchant and client settlement frequency is contractually timed in accordance with the terms of a merchant's association or client affiliation agreement.

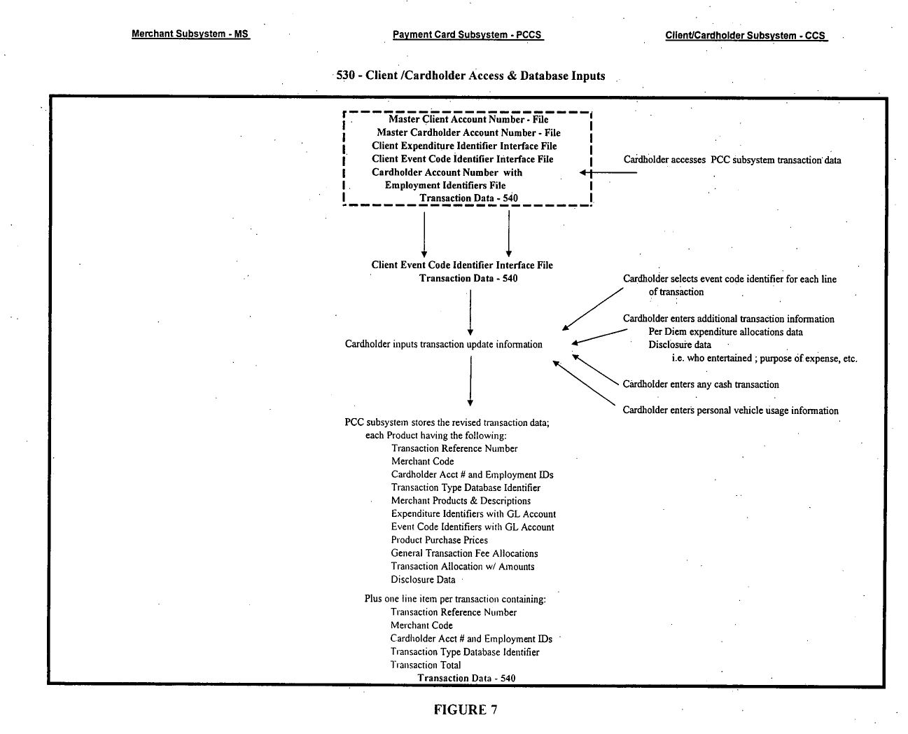

At step 530 of FIGS. 2 and 3, the payment card company provides a authorized cardholder access to the stored transaction data such as through one or more client user terminals 320 as shown in more detail in FIG. 7. Typically, this step is performed using a public communications network such as the internet. The authorized cardholder logs on the payment card company subsystem to gain secure access to the stored transaction data. At this point, the cardholder can enter additional expenditure data not captured or provided by a merchant, such as reimbursable personal vehicle usage mileage costs or reimbursable currency denominated transactions (domestic and foreign currency) incurred by the cardholder. It is also at step 530 that the cardholder reviews all transaction data, merchant transmitted transaction data and cardholder reimbursable mileage and currency transaction data, to associate an event code identifier with each transaction data line item, as well as to input any other data required in order to process an expense report; such as cost allocation identifiers with corresponding amounts and/or disclosure identifiers for any transaction data line items.

The client further accesses the payment card company subsystem for inputting and processing additional employee spending activity via the communication network. Currency transacted activity and vehicle mileage transaction activity (activity not specifically entered into the payment card company subsystem via the merchant transfer of transaction data) are manually added to the payment card company subsystem along with information that relates employee information and expenditure identifiers, for each of the currency and/or vehicle mileage transaction line items input via the one or more client/cardholder terminals. Cardholders review their specific payment card company subsystem transaction data and associated expenditure identifiers for accuracy, make corrections if necessary, and choose one of a plurality of client event code identifiers to each of the line items for reporting the expenditure activity. Thus the cardholder has made the necessary expenditure inputs and review of the transaction data to now provide a database on the payment card company subsystem that encapsulates all of the costs related to that cardholder's expenditures for a plurality of events (updated transaction data). The updated transaction data is now ready for cardholder processing of an expense report via access to the payment card company spending report subroutine depicted in step 560.

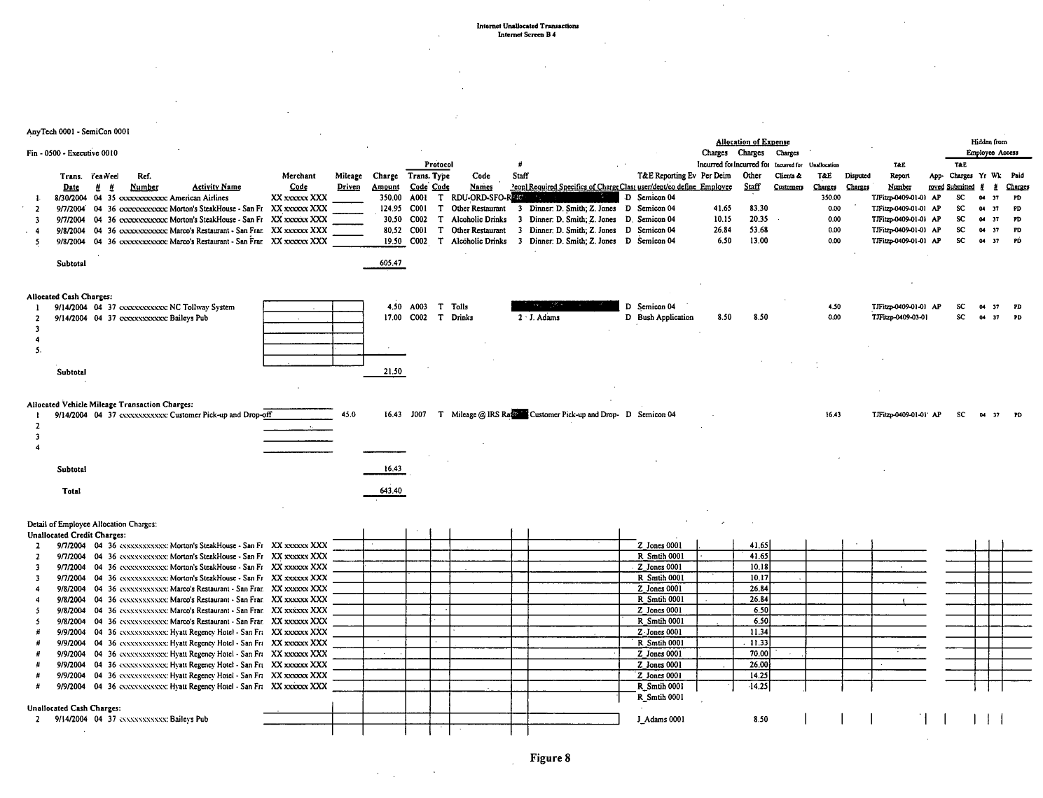

Step 540 of FIGS. 2 and 3 depicts the database of transaction data on the payment card company subsystem that contains transaction data at various stages of cardholder review and/or expense report processing. The data may be stored as shown in FIG. 8. The transaction data may include transaction data recently transmitted to the database from a merchant with no cardholder review of the activity at all or it may include transaction data that has been fully processed as an expense report transaction that has been through the supervisor authorization approval stage (discussed below) and any of the transaction statuses in between. Thus, where the cardholder has incurred expenditures that have not yet been sufficiently reviewed, identified with an event code identifier, or submitted as an expense by the cardholder or approved by the cardholder's supervisor; the payment card company subsystem has nonetheless been able to capture the accrued expenditures. And thereby is enabled to recognize the accrued expenditures for a timely financial accounting on an automated basis per the process depicted below as step 580—a process that automatically classifies client expenditures within the database to proper client ledger accounts; a process which had previously been a manual process.

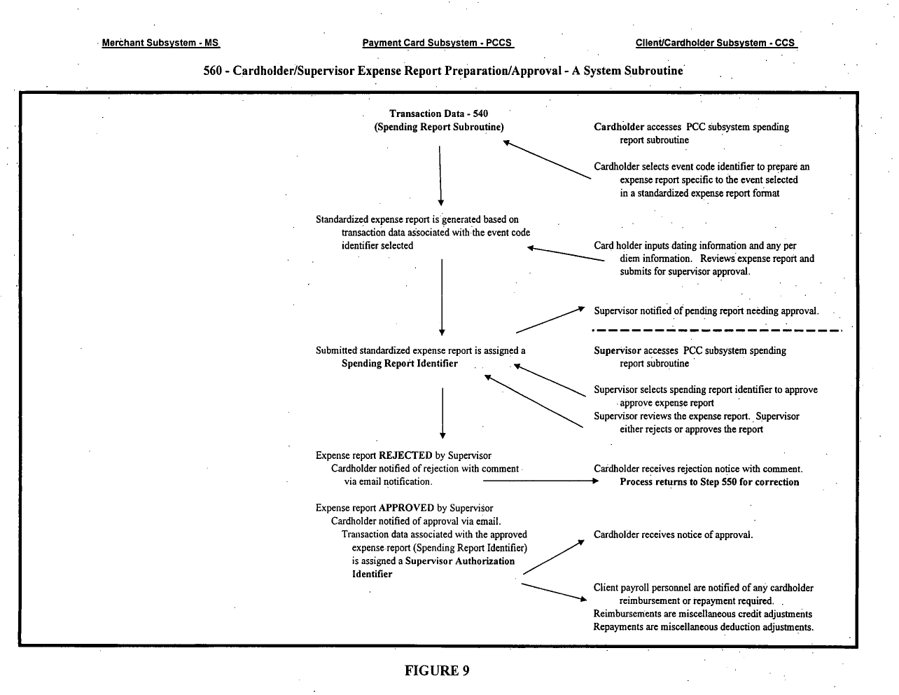

At step 560 of FIGS. 2 and 3, the payment card company provides an authorized cardholder access to the payment card company spending report subroutine and the stored updated transaction data via, as shown in more detail in FIG. 9. Typically, this step is performed using a public communications network such as the internet. The cardholder selects an event code identifier from a software code prompt in which the cardholder desires to process an initial expense report. The payment card company automation software accumulates all the transaction line items from the updated transaction data that matches the event code identifier selected and arranges the expenditures in a standardized flexible spending report format. Cardholder inputs the cardholder's dating information (beginning & ending date of the event activity for the cardholder), as well as inputting any per diem rate data. After review of expense report by the cardholder, the cardholder submits the expense report to a client supervisor for approval. The software subroutine will generate a spending report identifier and associate that identifier to each of the line item(s) of transaction data associated with the initial supervisor submission of the expense report. The cardholder's supervisor is notified via email of a pending expense report (with its associated spending report identifier) that needs approval. Subsequent access, to revise or to view a previously processed expense report, is provided through the utilization of the specific spending report identifier. When more than a single submission is required to obtain expense report approval, the spending report identifier will be amended with a incrementing suffix character.

Step 560 of FIGS. 2 and 3 additionally depicts, the payment card company providing an authorized cardholder supervisor access to the payment card company spending report subroutine and the stored updated transaction data. Typically, this step is performed using a public communications network such as the internet. The supervisor selects the expense report approval routing and selects the spending report requiring approval. The subsystem subroutine presents the standardized expense report based on the transaction data with an association to the spending report identifier. Supervisor either rejects or approves the expense report associated to the spending report identifier. If rejected, the subroutine sends email notification to cardholder with appropriate comments/questions from the supervisor—cardholder returns to step 530 to make appropriate corrections. If approved, the subroutine notifies the cardholder via email and assigns a supervisor authorization identifier to the transaction data associated with the spending report identifier approved. Additionally, for any cardholder expense report residue (reimbursement—amount due from employer—or repayment—amount due to employer), the cardholder's payroll personnel will be notified of a required payroll miscellaneous adjustment that needs to be processed within the client's payroll system. Cash transactions and personal vehicle usage amounts are automatically amounts due as a reimbursement to the cardholder. Company policy may mandate various expenditure identifiers as activity that is not appropriately charged as business spending, thus those expenditures would be earmarked by the automated software system as a repayment, an amount due from the cardholder.

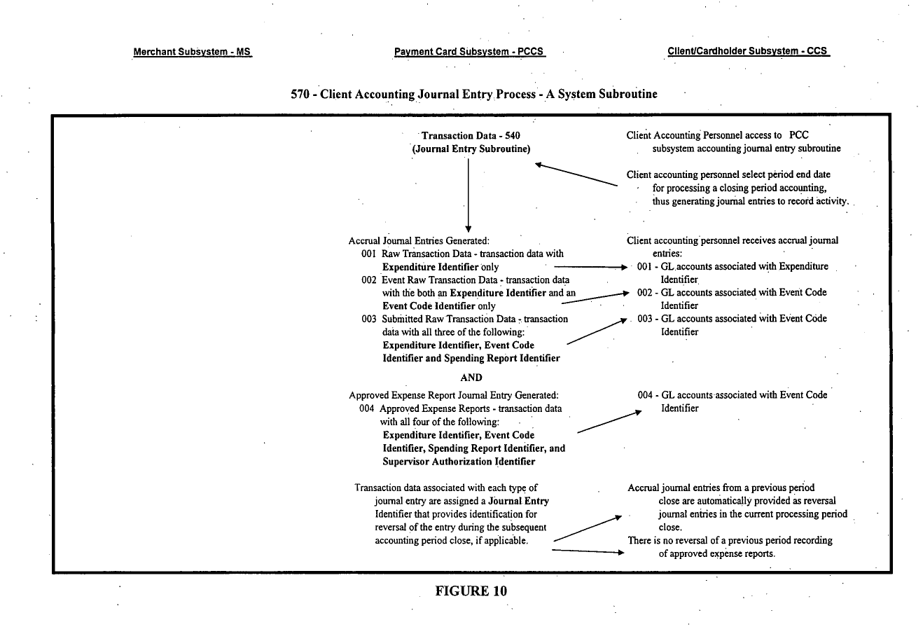

At step 570 of FIGS. 2 and 3, the payment card company provides authorized client accounting personnel access to the payment card company accounting journal entry subroutine and the stored updated transaction data via one or more client user terminals 320 as shown in more detail in FIG. 10. Typically, this step is performed using a public communications network such as the internet. The client accounting personnel selects an accounting period end closing date from a software code prompt, thus freezing the transaction database for analysis purposes to determine a bucket accumulation of expenditures based on the then current transaction data identifier statuses. Transaction data with only one of the four primary transaction identifiers—the expenditure identifier only—accumulates that data utilizing the GL accounts associated with the expenditure identifier. Whereas, transaction data with an event code identifier but the supervisor authorization identifier has not been assigned to the transaction data, is associated with the GL accounts associated with the event code identifier. For transaction data with all four of the primary identifiers associated with the transaction data, the GL accounts associated with the event code identifier is utilized. In the first two entry instances, the journal entries generated are classified as accrual entries and appropriately identified by the subroutine for reversal in the next accounting period close. Whereas the later entry instance is a final recording entry for the transaction data associated with a supervisor authorization identifier and appropriately identified by the subroutine, thus the entry is not reversed in a subsequent accounting period close. Thus, where the cardholder has incurred expenditures that have not yet been sufficiently reviewed, identified with an event code identifier, or submitted as an expense by the cardholder or approved by the cardholder's supervisor; the client is nonetheless able to capture the accrued expenditures, classify and sort the data consistently, and thereby enabling a more timely financial accounting recognition of costs and expenditures. And the accounting function of classifying client expenditures to proper ledger accounts (that had previously been a manual process) has been automated.

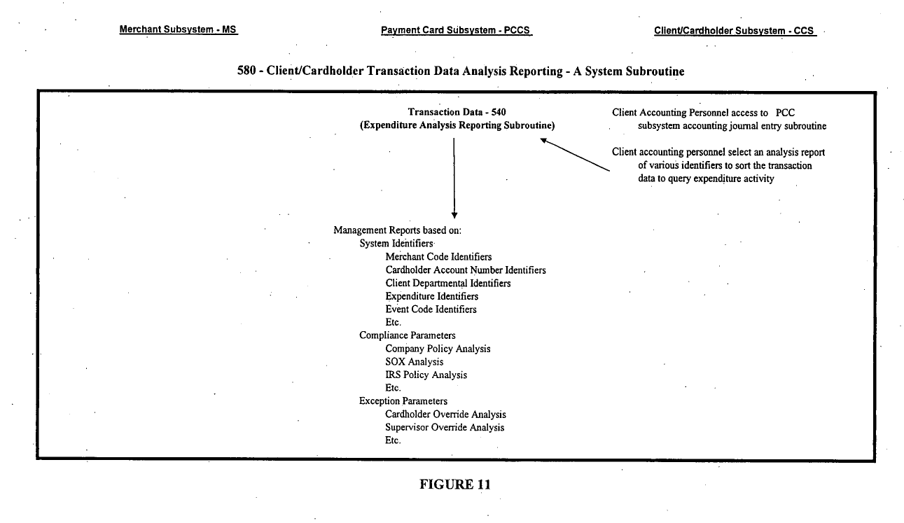

At step 580 of FIGS. 2 and 3, the payment card company provides authorized client accounting personnel access to the payment card company expenditure analysis reporting subroutine and the stored updated transaction data via one or more client user terminals 320 as shown in more detail in FIG. 11. Typically, this step is performed using a public communications network such as the internet. The client accounting personnel selects various identifier parameters and executes a sort of transaction data that fits the criteria selected, thus generating a analysis report of transaction data based on the selected criteria. Client management can utilize this subroutine to analyze company policy compliance, budgeting data, vendor (merchant) activity and contracting analysis, exception reporting, etc. for a whole host of various activities.

Various implementation techniques can be employed including various databases and spreadsheet (deemed a type of database for the purpose of this application).

The system can enable comparison of actual expenditure with per diem allowances and record an overages adjustment for repayment by a cardholder to the client employer. Such computations may be used in the payroll amount processing.

The disclosure of U.S. Patent Application Publication No. 20030088487 of Cheng et al., U.S. Pat. No. 6,442,526 to Vance et al, and U.S. Patent application Publication No. 20020178115 of Seo are incorporated herein by reference. The present invention can be referenced alongside those, and perhaps other systems, particularly building or existing infrastructures and relationships. In addition, certain modifications and improvements that are within the scope of the appended claims will occur to those skilled in the art upon a reading of the foregoing description.

We claim:

1. An expenditure accounting management system comprising a computer system configured to:
access transaction data representing a client expenditure in exchange for a plurality of products, the transaction data including one product identifier associated with one of the products and a different product identifier associated with a different one of the products;
store the transaction data in association with an expenditure identifier associated with the one product identifier and designating an account in a client accounting system and a different expenditure identifier associated with the different product identifier and designating a different account in the client accounting system; and
provide the client accounting system access to the stored transaction data including the stored expenditure identifiers.

2. The expenditure accounting management system of claim 1 wherein the computer system is further configured to associate the expenditure identifier with the one product identifier and associate the different expenditure identifier with the different product identifier.

3. The expenditure accounting management system of claim 1 wherein the computer system is further configured to receive the transaction data representing the client expenditure in exchange for the plurality of products.

4. The expenditure accounting management system of claim 1 wherein the computer system comprises a payment card company subsystem, a merchant subsystem, and a client subsystem.

5. A method of automated expenditure accounting management comprising:
associating a product identifier associated with a product and an expenditure identifier designating an account in a client accounting system;
associating a different product identifier associated with a different product and a different expenditure identifier designating a different account in the client accounting system;
storing transaction data including the product identifiers and associated expenditure identifiers; and
providing the client accounting system access to the transaction data and associated expenditure identifiers.

6. The method of claim 5 further comprising constructing a database storing the product identifiers associated with their respective expenditure identifier.

7. The method of claim 5 further comprising receiving client input related to reimbursable expenditures.

8. The method of claim 5 further comprising associating a client account with each expenditure identifier.

9. The method of claim 5 further comprising storing data in association with each expenditure identifier indicating whether the expenditure identifier relates to a personal or business transaction.

10. The method of claim 5 further comprising associating a product identifier with each of a plurality of merchant products.

11. The method of claim 5 further comprising conducting a transaction between a cardholder and a merchant.

12. The method of claim 5 further comprising querying transaction data to capture accrued expenditures.

13. The method of claim 5 further comprising associating an event code identifier with each expenditure identifier.

14. A storage medium comprising data combinable with a computer system such that the computer system:
associates a product identifier and an expenditure identifier designating an account in a client accounting system;
associates a different product identifier and a different expenditure identifier designating a different account in the client accounting system;
stores transaction data including the product identifiers and associated expenditure identifiers; and
provides the client accounting system access to the transaction data and associated expenditure identifiers.

15. The storages medium of claim 14 further comprising data combinable with the computer system such that a merchant subsystem transmits the product identifiers and expenditure identifiers.

16. The storage medium of claim 14 further comprising data combinable with the computer system such that a payment card company subsystem receives the product identifiers and expenditure identifiers.

17. The storage medium of claim 14 further comprising data combinable with the computer system such that the computer system provides a client cardholder access to the expenditure identifiers.

18. The storage medium of claim 14 further comprising data combinable with the computer system such that the computer system stores an event code identifier in association with each expenditure identifier.

19. A point of sale apparatus for a merchant comprising
a memory holding a data collection of purchased items in a single transaction with a charge card customer, each of the items being identified with an expenditure identifier, the data collection including an amount associated with each expenditure identifier and a charge card account to be charged in the single transaction, and
a transmitter to transmit the data collection to a credit card processor associated with the charge card used by the customer for payment to the merchant.

20. A charge card provider automation apparatus comprising
a receiver to receive from a merchant a data collection of purchased items in a single transaction with a charge card customer, each of the items being identified with an expenditure identifier, the data collection including an amount associated with each expenditure identifier and a charge card account to be charged in the single transaction, and
a memory to hold the received data collection, and
a transmitter to transmit the data collection to a credit card account member associated with the charge card used by the customer for payment to the merchant.

21. A charge card member automation apparatus comprising
a receiver to receive from a charge card provider a data collection of purchased items in a single transaction with a charge card customer, each of the items being identified with an expenditure identifier, the data collection including an amount associated with each expenditure identifier and a charge card account charged in the single transaction, and
a memory to hold the received data collection, and
processor apparatus to accumulate a plurality of received data collections and allocate charged amounts to card member accounting accounts according to received expenditure identifiers.

22. An automated expenditure accounting management system comprising a computer system including a merchant subsystem with a communication network, a client subsystem with a communication network, and a payment card company subsystem with a communication network, the computer system configured to:
associate a plurality of identifiers in association with transaction data related to purchases, including any general transaction fees charged by a merchant through the utilization of an electronic payment card by a payment cardholder;
associate a plurality of identifiers associated with transaction data related to purchases, including any general transaction fees charged by a merchant through the utilization of currency by a payment cardholder;
associate a plurality of identifiers associated with transaction data related to personal vehicle usage reimbursement expenditures by a cardholder;
associate the transaction data in association with the plurality of identifiers to an expense report subroutine within the payment card company subsystem for the processing of cardholder expense reports;
associate the transaction data in association with the plurality of identifiers to an accounting journal entry subroutine within the payment card company subsystem for the recording of cardholder expenditure; and
associate the transaction data in association with the plurality of identifiers to an expenditure analysis reporting subroutine within the payment card company subsystem for analyzing the database transaction data through client defined relational database management reports.

23. The automated expenditure accounting management system of claim 22 wherein the merchant subsystem of the computer system is further configured to:
receive via the communication network upon merchant association with a payment card company and periodically thereafter an interface file with a plurality of expenditure identifiers from the payment card subsystem;
associate each of a plurality of merchant products with an expenditure identifier thus generating a merchant expenditure identifier, interface file on the merchant subsystem, one of the plurality of products being associated with one of a plurality of expenditure identifiers and another of the plurality of products being associated with the same or a different expenditure identifier; and
comprise a point of sale apparatus with a transmitter/receiver and a memory.

24. The automated expenditure accounting management system of claim 23 wherein the merchant point of sale apparatus is configured to:
associate each of the purchased products in association with a single transaction by a cardholder with an expenditure identifier from the merchant expenditure identifier interface file;
associate any general transaction fee charged in association with a single transaction to each expenditure identifiers in an amount equal to the portion of that product fee basis;
associate each of the merchant products in association with a single transaction with a database code identifier;
associate each of the merchant products in association with a single transaction with the cardholder account number;
associate an amount in association with a single transaction that represents the total amount charged to a cardholder's account number;
hold the data collection of the purchased products from a single transaction with a cardholder in the point of sale memory, each of the products being identified with an associated expenditure identifier, the data collection including: (a) the amount associated with each product plus an amount that represents the pro-rata portion of any general transaction fee, (b) the cardholder's account number, (c) the database code identifier, and (d) a transaction total amount; and
transmit the data collection of purchased product in a single transaction to the payment card company associated with the cardholder's payment card that is used by the customer for payment of the purchased products.

25. The automated expenditure accounting management system of claim 22 wherein the client subsystem of the computer system is further configured to:
comprise a client automation apparatus with a transmitter/receiver and a memory;
provide the client access to the payment card company subsystem for the purpose of: (a) associating and inputting a client general ledger designated account to a client expenditure identifier interface file thus generating a client expenditure identifier with an associated general ledger designated account interface file, (b) inputting client defined event code identifiers with associated general ledger designated account thus generating a client event code identifier with associated general ledger designated account interface file, and (c) inputting client defined cardholder employment identifiers in association with each cardholder account number that is issued a electronic payment card by the payment card company thus generating a cardholder's account number with the cardholder's employment identifiers interface file;
provide the cardholder access to the payment card company subsystem for the purpose of accessing the data collection of a plurality of transactions associated with a one of the two database code identifier transaction data (a) reviewing the merchant transmitted data collection information to the payment card company, (b) associating a event code identifier with a general ledger designated account, adding cost allocation identifiers and amounts when applicable, and adding disclosure identifiers when applicable to each of the listed expenditure identifiers;
provide the cardholder access to the payment card subsystem expense report subroutine for the purpose of processing an employee expense report for supervisor approval by selecting an event code identifier and (a) inputting required dating parameters of the cardholder event expense period, (b) inputting applicable per diem rates for the event, and (c) submitting and notifying via email notification cardholder's supervisor of a report for approval, the computer system automatically associating a spending report identifier to the submitted unapproved expense report and associated expenditures identifiers;
provide the cardholder's supervisor access to the payment card company subsystem expense report subroutine for the purpose of (a) approving an expense report associated to a spending report identifier and notifying the cardholder of the approval via email notification, the computer system automatically associating a supervisor authorization identifier to the approved expense report and associated expenditure identifiers, or (b) rejecting an expense report associated to a spending report identifier and notifying the cardholder of the rejection via email notification with a supervisor commentary of rejection;
provide client accounting personnel access to the payment card company subsystem accounting journal entry subroutine for the purpose of conducting a period end closing on the transaction data for (a) accrual transaction activity including current period accrual and previous period automatic accrual reversal comprising: 1) raw data accrual including transaction data with an expenditure identifier associated with its general ledger designated account only; 2) event raw data accrual including transaction data expenditure identifier and an associated event code identifier with its associated general ledger designated account; and 3) submitted raw data accrual including transaction data expenditure identifier, an associated event code identifier with its general ledger designated account and a spending report identifier; or (b) approved expense reports transaction activity, transaction data expenditure identifier, an associated event code identifier with its general ledger designated account, a spending report identifier, and a supervisor authorization identifier; and
provide the client accounting personnel access to the payment card company subsystem expenditure analysis reporting subroutine for the querying of historical and current transaction data transaction data for management reporting analysis with dating sensitivity, identifier sensitivity, exception reporting and compliance reporting sensitivity.

26. The automated expenditure accounting management system of claim 22 wherein the payment card company subsystem of the computer system is configured to:
comprise a payment card company relational database transaction data computer server system to hold the automation software and transaction data;
comprise a payment card company automation apparatus with a transmitter/receiver and a memory;
receive via the merchant point of sale apparatus the data collection of purchased products in a single transaction with a payment cardholder, each of the products being identified with an associated expenditure identifier, the data collection including (a) an amount associated with each products plus an amount that represents the pro-rata portion of any general transaction fee such as sales tax, value added taxes, surcharges, and transaction fees, (b) the cardholder's account number, (c) the database code identifier, and (d) a transaction total amount;
amend the data collection of purchased products in a single transaction automatically with the associated general ledger designated account from the client expenditure identifier interface file, as well as associate the cardholder's employment identifiers from the cardholder's account number interface file to each of the products transmitted from the merchant;
store the data collection of purchased products in a single transaction with each of the products being identified with their associated expenditure identifier in association with its general ledger designated account, the data collection including (a) an amount associated with each product(s) plus an amount that represents the pro-rata portion of any general transaction fee such as sales tax, value added taxes, surcharges, and transaction fees (b) the cardholder's account number with employment identifiers, (c) the database code identifier, and (d) a transaction total amount;
store the transaction data in association with an expenditure identifier with one of a plurality of event code identifiers with a general ledger designated account selected from the event code identifier interface file, each one expenditure identifier being associated with an event code identifier and each different expenditure identifier being associated with the same or a different event code identifier;
store the transaction data in association with an expenditure identifier with one of a plurality of cost allocation identifiers and amounts when applicable for each associated expenditure identifier in which a per diem rate would apply;
store the transaction data in association with an expenditure identifier with a disclosure identifier such as a comment/description identifier for each associated expenditure identifier in which a identifier of those entertained would apply;
store the transaction data in association with an expenditure identifier with a computer generated spending report identifier upon submission of an expense report in association with the spending report subroutine submission;
store the transaction data in association with an expenditure identifier with a supervisor authorization identifier, to signifying only those expenditure identifiers associated with a spending report identifier for which a supervisor has approved the spending report for final client processing and recording as part of the spending report subroutine;
store the transaction data in association with an expenditure identifier with a journal entry identifier signifying the status of the merchant products associated with a cardholder account number for a specific client account with respect to accrual, reversal and final journal entry recording requirements in association with a period end closing process of the journal entry subroutine;
provide cardholder access to the stored transaction data for the purpose of inputting event code identifiers, cost allocation identifiers with amounts when applicable, and/or disclosure identifiers;
provide cardholder access to the spending report subroutine for the purpose of processing an expense report related to specific event code identifier and to input of expense report transaction data related to spending report submissions;
provide cardholder's supervisor access to spending report subroutine for the purpose of reviewing a cardholder's submitted expense report;
provide client accounting personnel access to the accounting journal entry subroutine for the purpose of processing accounting period closings; and
provide client accounting personnel access to the expenditure analysis reporting subroutine for the querying of transaction data for management analysis reporting.

27. The expenditure accounting management system of claim 26 wherein the payment card company computer subsystem is further configured to have a cardholder expense report preparation and approval process subroutine to:
provide access to a cardholder to selected transaction data which has an association to a specific event code identifier in a standardized payment card company expense report format;
associate a specific start date and a specific end date to the expense report identified to the specific event code identifier including the duration of time in days in which the cardholder incurred the event expenditures through the inputting of the dating event parameters;
associate, if applicable, a per diem rate parameter with respect to the per diem rate applicable to the event code identifier site location through the inputting of a per diem rate in association with the specific event code identifier;
store the prepared cardholder expense report through the submission of the completed expense report via the subroutine as a spending report with an associated system generated spending report identifier associated to each of the products that are associated with the specific event code identifier, the spending report identifier having a suffix character set to identify resubmission of amended expense reports, and notify the supervisor via email notification of a spending report identifier that needs approval;
provide access to the cardholder's supervisor to select a spending report identifier for the purpose, (a) approving an expense report associated to a spending report identifier and notifying the cardholder of the approval via email notification and transmitting reimbursement/repayment data from a cardholder's expense report submission that is associated with the supervisor authorization identifier in association with a specific spending report identifier to the client's payroll department for inclusion with the next scheduled cardholder payroll period, or (b) rejecting an expense report associated to a spending report identifier and notifying the cardholder of the rejection via email notification with a supervisor commentary of rejection; and
associating a system generated supervisor authorization identifier to the approved spending report identifiers; and
store the approved cardholder expense report associated to an approved spending report identifier in association with a supervisor authorization identifier.

28. The expenditure accounting management system of claim 26 wherein the payment card company computer subsystem is further configured to have an accounting journal entry subroutine to:
provide the client personnel access to the payment card company subsystem accounting journal entry subroutine for the purpose of generating and approving period end closing journal entries in association with the transaction data for (a) accrual transaction activity including current period accrual and previous period automatic accrual reversal, 1) raw data accrual, transaction data with an expenditure identifier associated with its general ledger designated account only; 2) event raw data accrual, transaction data expenditure identifier and an associated event code identifier with its associated general ledger designated account; 3) submitted raw data accrual, transaction data expenditure identifier, an associated event code identifier with its general ledger designated account and a spending report identifier; or (b) approved expense reports transaction activity, transaction data expenditure identifier, an associated event code identifier with its general ledger designated account, a spending report identifier, and a supervisor authorization identifier;
associating journal entry identifiers to each of the products within the client specific transaction database as determined by cardholder account numbers associated with a specific client account that indicates whether the merchant products are associated or unassociated with an expenditure identifier, event code identifier, spending report identifier and/or a supervisor authorization identifier as of the processing date of a period end closing subroutine process including journal entry identifiers associated with the merchant products to identify whether the status of the merchant product as of the processing date is an accrual status product requiring an automatic reversal in the subsequent accounting period close or a final recoded status product wherein no reversal in the subsequent accounting period close; and
store the journal entry identifiers in association with the period end closing routine process with the merchant products in accordance with the relevant status of the merchant products as of the date of the processing.

29. The expenditure accounting management system of claim 26 wherein the payment card company computer subsystem is further configured to have an expenditure analysis reporting subroutine to:
provide the client personnel access to the payment card company subsystem expenditure analysis reporting subroutine for the querying of transaction data including historical and current transaction data for management reporting analysis with selection sensitivity for transaction dates, identifiers, exception reporting and compliance reporting.

30. The expenditure accounting management system of claim 22 wherein the computer system is further configured to receive the transaction data representing expenditures in exchange for the plurality of products, its associated expenditure identifiers, database code identifier, cardholder's account number, and the transaction total amount.

31. The expenditure accounting management system of claim 22 wherein the computer system is further configured to receive the transaction data representing expenditures in exchange for the plurality of products, with the purchase amount for the merchant product, as well as the amount that represents the pro-rata portion of any general transaction fee including sales tax, value added taxes, surcharges, or transaction fees.

32. A method of automated expenditure management comprising:
associating an expenditure identifier that is associated with a general ledger designated account to the merchant product from a single transaction;
associating the same or a different expenditure identifier with a general ledger designated account to a different merchant product from a single transaction;
associating a database code identifier to each of the merchant products from a single transaction;
associating a cardholder account number that is associated with the employment identifiers to each of the merchant products from a single transaction;
associating a merchant product from a single transition further with the input of an event code identifier that is associated with a general ledger designated account, a cost allocation identifiers with an amount, and a disclosure identifier;
associating a different merchant product from a single transaction further with the input of a different event code that is associated with a general ledger designated account, a cost allocation identifier with the an amount, and a disclosure identifier;
associating a spending report identifier and a supervisor authorization identifier to each of the merchant products as part of the preparation and approval process of the specific event code identifier expense report subroutine submission;
storing the transmitted transaction data with an expenditure identifier that is associated with automatically with the general ledger designated account for a merchant product from a single transaction;
storing the transmitted transaction data with the same or a different expenditure identifier that is associated automatically with the general ledger designated account for a different merchant product form a single transaction;
storing the transmitted transaction data with a database identifier for each of the merchant products from a single transaction;
storing the transmitted cardholder account number that is associated with the employment identifiers for each of the merchant products from a single transaction;
storing the inputted event code identifier that is associated with a general ledger designated account for each of the merchant products from a single transaction;
storing the inputted cost allocation identifiers with an amount for each of the merchant products from a single transaction;
storing the inputted disclosure identifier for each of the merchant products from a single transaction;
storing the automatically generated spending report identifiers to each of the merchant products from a single transaction when submitting an expense report as part of the spending report subroutine;
storing the automatically generated supervisor authorization identifier to each of the merchant products from a single transaction when a submitted expense report is approved as part of the spending report subroutine; and
providing the cardholder, the cardholder's supervisor, and client personnel including the client general ledger accounting system access to the stored transaction data including expenditure identifiers that are associated with a general ledger designated account, cardholder account number that are associated with employment identifiers, event code identifiers that is associated with a general ledger designated accounts, cost allocation identifiers with amounts, disclosure identifiers, spending report identifiers, and supervisor authorization identifier.

33. The method of claim 32 further comprising constructing a database of transaction data storing the products with each of their respective identifiers and any associated general ledger designated accounts and employment identifiers.

34. The method of claim 32 further comprising receiving client personnel input related to identifier maintenance, company policy compliance parameters and reimbursable expenditures.

35. The method of claim 32 further comprising receiving cardholder input related to cardholder related identifier maintenance and reimbursable expenditures.

36. The method of claim 32 further comprising associating a general ledger designated account with each expenditure identifier, as well as associating the same or a different general ledger designated account with each event code identifier.

37. The method of claim 32 further comprising associating the related employment identifiers with each cardholder account number.

38. The method of claim 32 further comprising storing data in association with each product indicating whether the product purchased by the cardholder from a single transaction is associated to a business expenditure or personal expenditure.

39. The method of claim 32 further comprising associating an expenditure identifier from the merchant expenditure identifier interface file to each of a plurality of merchant products.

40. The method of claim 32 further comprising conducting a transaction between a merchant and a cardholder.

41. The method of claim 32 further comprising associating an event code identifier that is associated with a general ledger designated account with each merchant product.

42. The method of claim 32 further comprising a method for associating transaction data, as part of the expense report subroutine, that has not yet been submitted as an expense report and thus a spending report identifier is not yet been associated with the product, and an event code identifier has not been associated with said product as raw data accrual information for the accounting journal entry subroutine to the client's general ledger accounting system with a automatic reversal feature during the client's next accounting period by associating each such product with the general ledger designated account that is associated with that product's expenditure identifier.

43. The method of claim 32 further comprising a method for associating transaction data, as part of the expense report subroutine, that has not been submitted as an expense report and thus a spending report identifier is has not been associated with the product, but an event code identifier has been input and thus associated with said product as event raw data accrual information for the accounting journal entry subroutine to the client's general ledger accounting system with a automatic reversal feature during the client's next accounting period by associating each such product with the general ledger designated account that is associated with that product's event code identifier.

44. The method of claim 32 further comprising a method for associating transaction data, as part of the expense report subroutine, that has been submitted as an expense report and thus a spending report identifier has been associated with the product, and event code identifier has been associated with said product, but a supervisor authorization identifier does not yet indicate approval as submitted raw data accrual information for the accounting journal entry subroutine to the client's general ledger accounting system with a automatic reversal feature during the client's next accounting period by associating each such product with the general ledger designated account that is associated with that product's event code identifier.

45. The method of claim 32 further comprising a method for associating transaction data, as part of the expense report subroutine, that has been submitted as an expense report and thus a spending report identifier is has been associated with the product, an event code identifier has been associated with said product, and the supervisor authorization identifier indicates spending report approval as an approved spending report information for the accounting journal entry subroutine to the client's general ledger accounting system with a no automatic reversal feature during the client's next accounting period by associating each such product with the general ledger designated account that is associated with that product's event code identifier.

46. A storage medium comprising data combinable with a computer system such that the computer system:
associates a merchant product and an expenditure identifier designating a general ledger designated account in a client general ledger accounting system;
associates a different merchant product and the same or a different expenditure identifier designating the same or a different general ledger designated account in a client general ledger accounting system;
associates a merchant product and an event code identifier designating a general ledger designated account in a client general ledger accounting system;
associates a different merchant product and the same or a different event code identifier designating the same or a different general ledger designated account in a client general ledger accounting system;
stores transaction data including the merchant products and associated expenditure identifiers and associated event code identifiers; and
provides the cardholder, cardholder's supervisor, and client personnel including the client general ledger accounting system access to the transaction data, the associated expenditure identifiers and event code identifiers that are associated with merchant products.

47. The storage medium of claim 46 further comprising data combinable with the computer system such that a merchant subsystem transmits the merchant products, expenditure identifiers, database identifier, and cardholder's account number, along with the amount of each merchant product price cost, the amount that represents the pro-rata portion of any general transaction fee such as sales tax, value added taxes, surcharges, transaction fees, and the total transaction amount.

48. The storage medium of claim 46 further comprising data combinable with the computer system such that a payment card company subsystem receives the merchant products, expenditure identifiers, database identifier, and cardholder's account number along with the amount of each merchant product price cost, the amount that represents the pro-rata portion of any general transaction fee such as sales tax, value added taxes, surcharges, transaction fees, and the total transaction amount.

49. The storage medium of claim 46 further comprising data combinable with the computer system such that a payment card company subsystem amends the general ledger designated account that is associated with the received expenditure identifier and amends the employment identifiers associated with the received cardholder's account number to the transaction data previously stored.

50. The storage medium of claim 46 further comprising data combinable with the computer system such that the computer system provides a cardholder access to the expenditure identifiers.

51. The storage medium of claim 46 further comprising data combinable with the computer system such that the computer system provides a cardholder access to the event code identifiers with their associated general ledger designated accounts, the cost allocation identifiers with amounts and disclosure identifiers for the purpose of inputting relevant data.

52. The storage medium of claim 46 further comprising data combinable with the computer system such that the computer system stores the event code identifier with its associated general ledger designated account, the cost allocation identifiers with amounts and disclosure identifiers.

53. A point of sale apparatus for a merchant comprising:
memory holding a data collection of purchased products in a single transaction with a payment card customer, each of the products associated with an expenditure identifier, the data collection including an amount associated with purchase price of each product, the amount that represents the pro-rata portion of an general transaction fee such as sales tax, value added taxes, surcharges, transaction fees, the total transaction amount, and a cardholder's account number to be charged in the single transaction; and
a transmitter to transmit the data collection to a payment card company associated with a payment card used by the customer for payment of the merchant products.

54. A payment card company automation apparatus comprising:
a receiver to receive from a merchant a data collection of purchased products in a single transaction with a cardholder, each of the products being identified as a merchant product with an associated expenditure identifier, the data collection including an amount associated with each product, the amount that represents the pro-rata portion of any general transaction fee such as sales tax, value added taxes, surcharges, transaction fees, the total transaction amount, and a cardholder's account number to be charged in the single transaction;
memory to hold the received data collection; and
a transmitter to transmit the data collection to a client and/or cardholder associated with the cardholder account number used by the customer for payment of the merchant products.

55. A client business transactions or a cardholder personal transactions automation apparatus comprising:
a receiver to receive from a payment card company a data collection of purchased products in a single transaction with a payment card customer, each of the products with an associated expenditure identifier, the data collection including (a) an amount associated with each product(s) plus an amount that represents the pro-rata portion of any general transaction fee such as sales tax, value added taxes, surcharges, transaction fees, (b) the cardholder's account number, (c) the database code identifier, and (d) a transaction total amount charged;
memory to hold the received data collection; and
processor apparatus to accumulate a plurality of received data collections and allocate charged amounts to the cardholder's account number according to received product(s) and expenditure identifiers.
